(19) United States
(12) Patent Application Publication
(10) Pub. No.: US 2018/0168369 A1
(43) Pub. Date: Jun. 21, 2018

(54) PORTABLE GIFT WRAP ROLL DISPLAY

(71) Applicant: Steven Goldmeier, Plainview, NY (US)

(72) Inventor: Steven Goldmeier, Plainview, NY (US)

(21) Appl. No.: 15/842,013

(22) Filed: Dec. 14, 2017

Related U.S. Application Data
(60) Provisional application No. 62/435,359, filed on Dec. 16, 2016.

(51) Int. Cl. A47F 5/11; A47F 5/13; A47F 5/08; B65D 5/52; A47B 57/58

(52) U.S. Cl. CPC A47F 5/116; A47F 5/132; A47F 5/0807; B62B 2501/062; A47F 5/114; B65D 5/528; A47B 57/58; B65D 5/526

(57) ABSTRACT

A portable display supports gift wrap rolls, and optional accessories, such as ribbon bows and/or adhesive tape dispensers. The wrapping paper roll displays disclose stash the rolls vertically as in a first embodiment, as well as to stack in the rolls horizontally in a further embodiment. The portable displays holds rolls of gift wrapping paper, and optionally decorative ribbon bow packages, and/or adhesive tape dispensers. A top panel above the top of the vertically supported gift wrap rolls supports gift wrap ribbon bows on displays. The portable gift wrap roll display panels have cutout, foldable, C-shaped restraint portions which are bent outwardly and upwardly from the flat panel with a recess provided therein for insertion of one or more gift wrap rolls therein.

### RELATED APPLICATIONS

This application claims the benefit of provisional patent application Ser. No. 62/435,359 filed on Dec. 16, 2016 under 35 USC§ 119(e). The ‘359’ application is incorporated by reference herein.

### FIELD OF THE INVENTION

The present invention relates to portable gift wrap roll display panels for displaying gift wrap rolls in retail establishments.

### BACKGROUND OF THE INVENTION

Among related prior art for gift wrap roll displays include the following commercially available gift wrap roll displays for vertical display of gift wrap rolls:

The “cdn.homedit.com photograph shows a door mounted gift wrap display that includes a wall mounted panel with shelves for ribbons and accessories above a tray with cables for holding gift wrap rolls vertically.

The www.zstsd.com website shows a commercially available display with a tray on the bottom, where gift wrap rolls are displayed vertically between protruding divider rods.

The img.papersale.net website shows another self standing display with a bottom tray and protruding divider rods to display gift wrap rolls vertically.

The s-media-cache-ako.pinimg.com website shows a dual shelf display where gift wrap rolls are displayed vertically within sections divided by divider rods.

Additionally, the following patent references are relevant as follows:

| U.S. Pat. No. | First Named Inventor | Issue Date |
|---|---|---|
| DES 167,820 | Zel | Sep. 23, 1952 |
| 2,793,760 | Zel | May 28, 1957 |
| DES 265,024 | Johnson | Jun. 22, 1982 |
| DES 296,283 | Hardy | Jun. 21, 1988 |
| DES 349,202 | Eliadis | Aug. 2, 1994 |
| 5,443,168 | Dyment | Aug. 22, 1995 |
| 6,123,197 | Marquez | Sep. 22, 2000 |
| 6,698,589 B1 | Johnson | Mar. 2, 2004 |
| 7,500,574 B1 | Miller | Mar. 10, 2009 |
| 7,584,854 B2 | Chandaria | Sep. 8, 2009 |
| 7,665,612 B2 | Turner | Feb. 23, 2010 |
| 8,210,348 B1 | Chapman | Jul. 3, 2012 |
| 8,485,370 B2 | Dewhurst | Jul. 16, 2013 |
| 8,915,381 B2 | Brozak | Dec. 23, 2014 |
| 9,215,939 B2 | Zobel | Dec. 22, 2015 |

The two patents (utility and design) of Zel each show racks for displaying gift wrap paper rolls.

The Johnson '024 of American Greetings Company shows built-in shelves for displaying gift wrap rolls vertically.

While Hardy '283 does not display gift wrap rolls, it does show end display stands at the end of merchandising shelves.

Eliadis '202 is important because it has a tray at the bottom and a C-shaped rectangular retainer clip at the top, to vertically hold gift wrap rolls.

Dyment '168 shows the concept of portable, cardboard displays in general.

Marquez '197 and Johnson '589 both show boxes with areas to hold gift wrap rolls vertically.

Miller '574 shows a collapsible display rack for gift wrap rolls.

Chapman '348 and Chandaria '854 are important because they show how to display gift wrap rolls together with Scotch tape dispensers.

Dewhurst '370 is important because it discloses a corrugated cardboard display.

Brozak '381 discloses a display panel having a tray at the bottom and wall sections to hold vertically stored gift wrap rolls.

Zobel '939 shows a wall-mountable display bin for displaying gift wrap rolls vertically with a tray on the bottom.

The above references do not disclose a portable door or wall mounted gift wrap display, where the display panel has foldable cutouts to form C-shaped rectangular retainer harness or collar sections to hold gift wrap rolls for display.

### OBJECTS OF THE INVENTION

It is therefore an object of the present invention to provide a portable upright, flat gift wrap roll display which can be suspended from a wall, door or end panel of retail shelving.

It is also an object of the present invention to provide convenient gift wrap roll displays which are easily mountable, and which can display gift wrap paper rolls and optional accessories, such as ribbon bows or adhesive tape dispensers.

It is further an object of the present invention to provide foldable cutout restraining harnesses or collars from a portable, mountable or self-standing upright, flat panel, for display of gift wrap rolls and related wrapping paper accessory items.

Other objects will become apparent from the following description of the present invention.

### SUMMARY OF THE INVENTION

In keeping with these objects and others which may become apparent, the present invention describes wrapping paper roll displays, which stash the rolls vertically or horizontally with foldable, cutout restraining harnesses or collars, punched out from a disposable, portable panel, preferably of cardboard or foam board. The portable display supports gift wrap rolls, and optional accessories, such as ribbon bows and/or adhesive tape dispensers.

The wrapping paper roll displays disclose stashing the rolls vertically as in first and second embodiments, as well as to optionally stash the rolls horizontally in a further embodiment.

While size may vary, the portable gift wrap roll display has preferable dimensions of about 43″×18″×31/4″, with fasteners, such as, for example, four inch hooks.

The portable display stores rolls of gift wrapping paper, and optionally decorative ribbon bow packages, and/or adhesive tape dispensers, preferably a top auxiliary panel above the top of the main panel supporting vertically oriented gift wrap rolls, supports gift wrap ribbon bows on displays.

A three inch rise over the top of the upper ribbon bows top accessory panel has apertures for accommodating attachment means, such as hooks or rods, therethrough.

A first embodiment for a portable gift wrap roll display includes a disposable panel with cutout, foldable templates that form C-shaped restraining harness or collar sections, which are cut out on three sides, with a fourth foldable side being attached to the panel, wherein the C-shaped portions are bent outwardly and upwardly from the flat panel, with a recess provided therein, for insertion of one or more gift wrap rolls (typically 18″m 24″ ir 30″ in length) therein, in a generally vertical storage display orientation.

To keep the vertically stored wrapping paper rolls from falling down, the bottoms thereof are supported in a lower tray having a pair of wings which are bendable at respective opposite edges of the main flat panel, and a lower tab portion bendable along the bottom edge of the main flat panel and again bendable parallel to the bottom edge, where holes are provided for insertion of further attachment tabs of the wings joining the lower tabs portion to form a rectangular tray at the bottom of the flat panel display for gift wrap rolls.

The formation of the bottom tray is achieved by folding and joining edge wing portions to form a hollow, open-topped box-like tray portion at the bottom of that display panel.

The C-shaped restraint harness or collar sections are formed by cutting and folding, for holding the gift wrap rolls therein. In front of the rolls, the formed bottom tray can have sufficient storage space to store adhesive tape dispensers therein.

For additional storage, a further auxiliary tray can be attached by strips of fasteners, such as Velcro® hook and loop strip or tape behind the display panel, suspending the auxiliary tray below the primary tray of the main portable display panel.

FIGS. 9-12 show a further alternate embodiment where the rolls are supported by punch out restraints that hold respective gift wrap rolls horizontally therein.

The portable gift wrap displays of the present invention enhances the display of gift wrapping paper rolls. The addition of the foldable, punch out restraining harnesses or collars greatly enhances the storage of the gift wrap rolls.

The use of foldable, punch out restraining means provides the disposable, portable display panel with a way to store the rolls formed from the flat panel.

The important storage function of the display panel is maintained with the punch out, foldable restraining feature.

The wrapping paper roll displays stash the rolls vertically as in a first embodiment, as well as the rolls horizontally in a further embodiment.

In general, the portable gift wrap roll display for displaying gift wrap rolls in retail establishments, includes the following:

a) an upright flat display panel having foldable cutouts forming retainers to hold gift wrap rolls therein for display,

b) wherein the cutouts are cut from said flat display panel along scored edges and a non-cut foldable edge joining said flat panel and said cutouts; and,

c) wherein the flat display panel is held positionally upright by at least one holder device maintaining the flat display panel positionally secure in the upright position.

The cutout gift wrap roll retainers can be configured to either store the gift wrap rolls either substantially vertically, or substantially horizontally.

The cutout gift wrap roll retainers may be, for example, punch-out C-shaped rectangular retainer harnesses or punch-out collar sections. The C-shaped restraining harnesses are cut out on three sides, with a fourth foldable side being foldably attached to the panel, wherein the C-shaped portions are bent outwardly and upwardly from the flat panel, with a recess provided therein, for insertion of one or more gift wrap rolls therein, in a generally vertical storage display orientation.

Whiel each retainer can accommodate a plurality of substabtially vertically oriented gifyt wrap rolls therein, in an optional embodiment each of said gift wrap roll restraining collar retainers snugly holds a single gift wrap roll therein.

The lower foldable base to maintain said upright flat display panel in a self-standing position may include a tray having a horizontally extending flat floor engaging surface, to hold the bottoms of the gift wrap rolls in the substantially vertical orientation for retail display, keeping the vertically stored wrapping paper rolls from falling down, wherein the bottoms of said rolls thereof are supported in the lower tray. The lower tray is formed from a pair of wings extending from lower sides of the flat display panel. These wings are bendable at respective opposite edges of the main flat panel, and a lower tab portion is bendable along the bottom edge of the main flat panel and again bendable parallel to the bottom edge, where respective holes are provided for insertion of further attachment tabs of the wings, thereby joining the lower tab portions, to form the rectangular tray at the bottom of the upright flat panel display for retaining respective bottoms of the gift wrap rolls.

To maintain the upright flat panel in an upright position, in a suspended mode, the positionally upright holder device for the upright flat display panel includes upper apertures engaging protruding wall or door fasteners.

Optionally, in a self standing mode, the positionally upright holder device for the upright flat display panel includes a lower foldable base to render the gift wrap roll display self standing upon a floor or horizontal shelf surface.

Also optionally, the upright flat display panel includes a foldable open bin to store accessories, selected from the group consisting of ribbon, gift labels, ribbon bows, or adhesive tape dispensers.

This foldable open bin can be located at a top, mid or lower region of the upright flat display panel.

Preferably, when suspended from a vertical surface, such as a door, a wall or an end of a retail shelving assembly, the upright flat display panel includes a rise portion located at the top, over the top of the upper foldable bin, where the rise has the aforementioned apertures to accommodate protruding fasteners, such as hooks or rods, extending therethrough, for suspending and maintaining the upright flat display panel in an upright position against the vertical surface.

For additional storage, a further auxiliary tray is attachable by fasteners behind the upright flat display panel, which suspend the auxiliary tray below a first primary tray of the upright flat display panel.

Where the gift wrap rolls are horizontally supported by punch out retainer collars extending from said upright flat holding panel respective gift wrap rolls horizontally therein, these retainer collars are formed from V-shaped foldable cutouts formed by templates of foldable sub-panels, which are foldable at a respective horizontal mid fold line and scored punch out lines, forming diamond shaped retainer collars when viewed in cross section from the side of the upright, generally flat display panel.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a perspective view of a first embodiment for a portable gift wrap roll display of the present invention, showing gift wrap paper rolls, adhesive tape dispensers and ribbon bows supported thereon;

FIG. 2 is a front elevation view thereof, showing the tray portion in an unfolded position the present invention;

FIG. 3 is a close-up detail view of the folding of the tray portion of the portable gift wrap roll display of the present invention;

FIG. 4 is a close-up detail view of the folding upward of a roll restraint belt of the gift wrap roll display of the present invention;

FIG. 5 is an exploded view showing the portable gift wrap roll display assembled and being suspended upon wall or door mounted hooks, and showing the insertional position of the gift wrap rolls, adhesive tape dispensers, and ribbon bows supported by the portable gift wrap roll display;

FIG. 6 is a close-up crossectional view of the tray portion having the bottom of a gift wrap roll and an adhesive tape dispenser supported therein;

FIG. 7 is an exploded perspective view of a further accessory tray being attached to the lower tray portion of the portable gift wrap roll display;

FIG. 8 is a perspective view of an alternate embodiment for a portable gift wrap roll display with a plurality of restraint belts each holding a roll therein;

FIG. 9 is a perspective view of a second alternate embodiment for a portable gift wrap roll display, showing horizontal displays of gift wrap rolls, with mounts for display of ribbon bows and adhesive tape dispensed thereon;

FIG. 10 is a perspective view of the second alternate embodiment shown with an optional lower tray for display of adhesive tape dispensers therein;

FIGS. 11 and 12 are left side and right side elevation views of the embodiment of FIG. 10 for a portable gift wrap roll display with bottom trays.

### REFERENCE NUMERALS

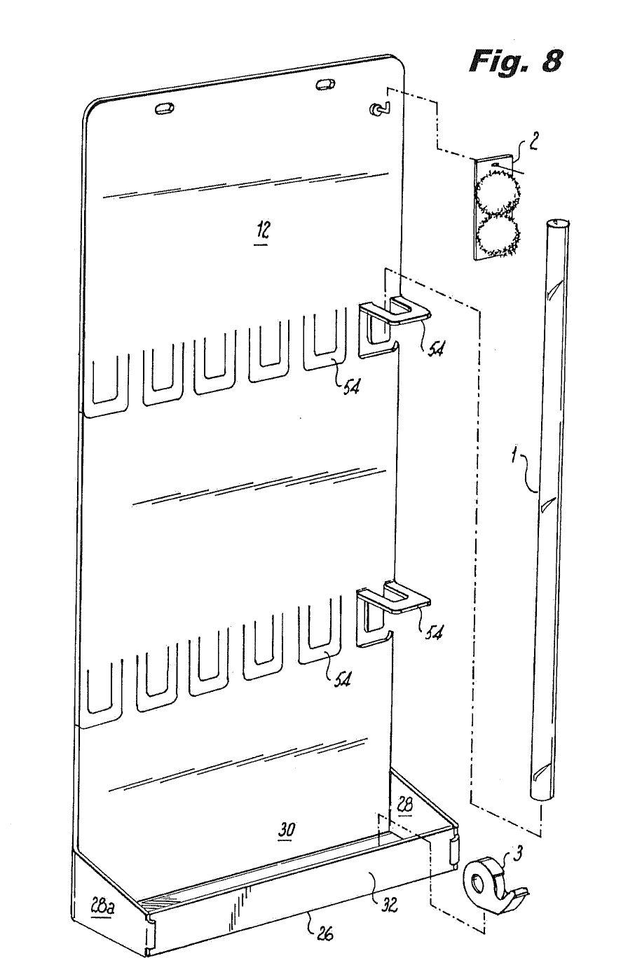

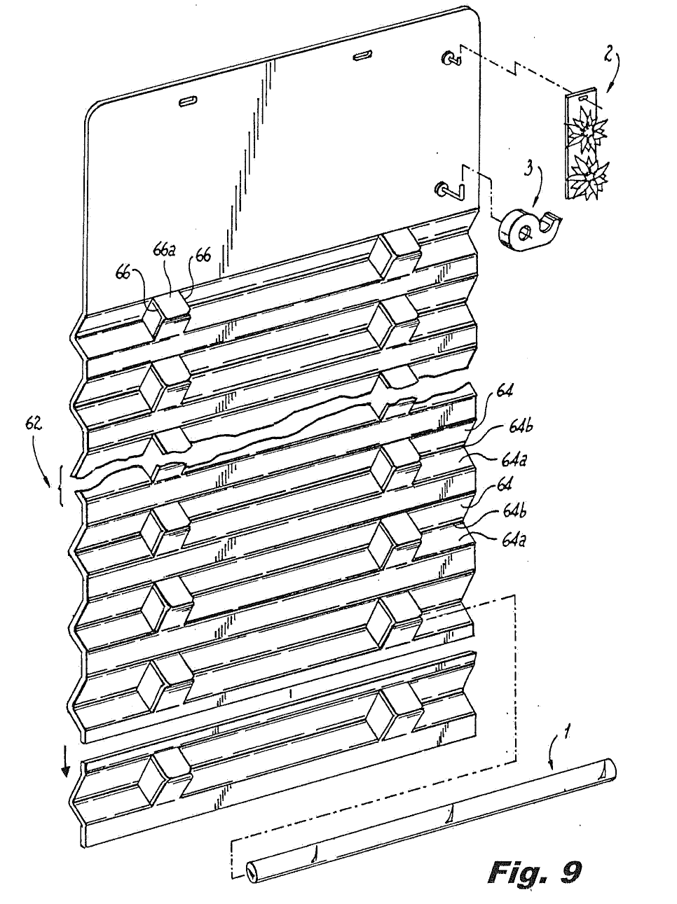

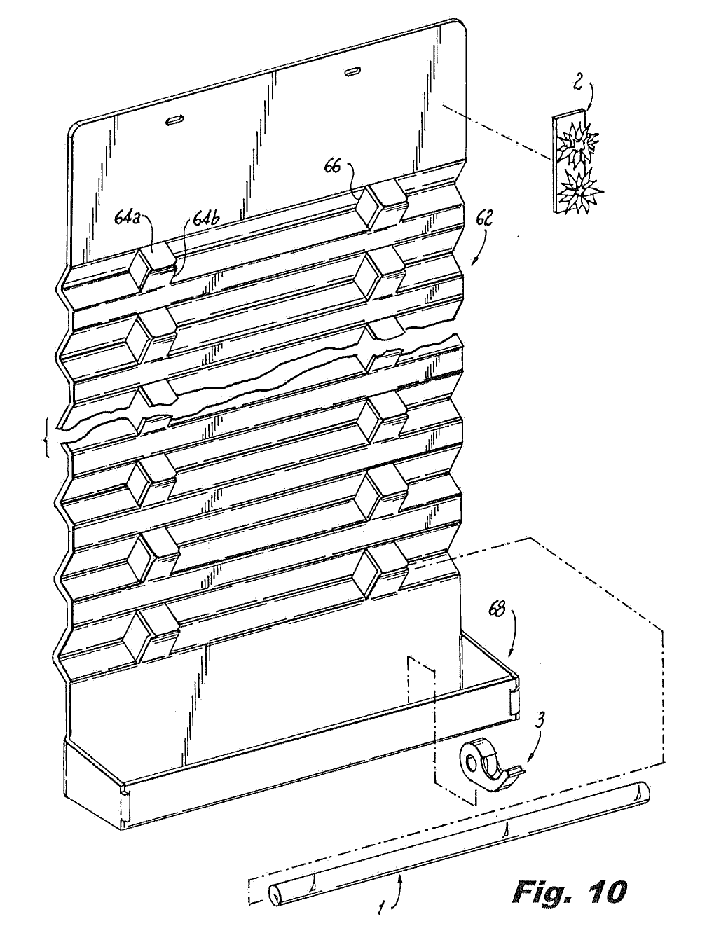

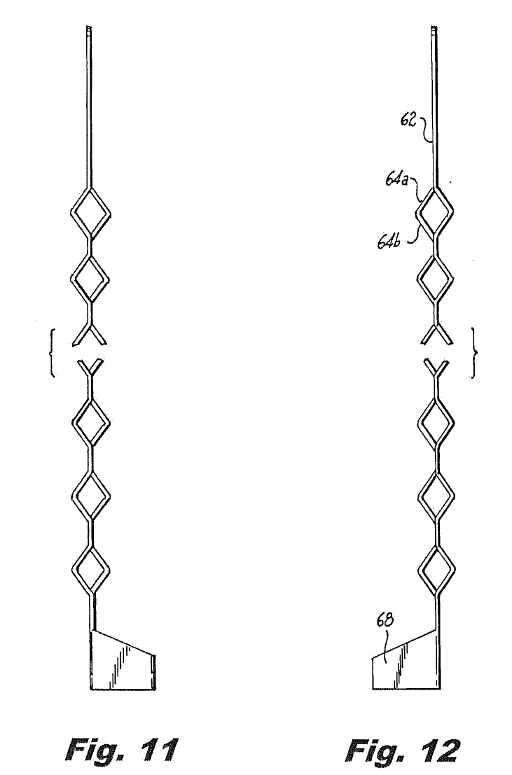

For illustrative purposes only, a preferred mode for carrying out the invention is described herein, wherein the following reference numerals are non-limiting examples.
1—Gift Wrap Paper Roll
2—Package of bows 2a
3—Tape Dispenser
4—Wall with hooks 22
10—Display unit
12—Main panel
14—C-shaped restraining collars
14a—Cut out edges of 14
14b Foldable top of 14
16—Recess in collars 14
18—Top panel with indicia 24 and hook holes 20
20—Apertures for hooks 22
22—Hooks for holding display 10
26—Lower tray
28, 28a—Wings of panel 12 that form sides of tray 26
29—Vertical fold line of wings 28, 28a from panel 12
30—Tab panel below fold line 31 that forms base of tray 26
32—Distal end panel that forms front of tray 26
33—Fold line between 30 and 32
34—Distal edge of panel
35, 35a—Oblong apertures in base panel 30 of tray 26 and in front panel 32 of tray 26
36, 36a—Lower tabs of wings 28, 28a
37, 37a—Side tabs of wings 28, 28a
40—Auxiliary lower tray
42—Velcro® hook and loop strip for low tray 40
54—C-shaped collars of FIG. 8
62—Panel for horizontal storage of FIGS. 9-12
64, 64a—Upper and lower sub panels of V-shaped collars of FIGS. 9-12
64b—Fold line of V-shaped collars of FIGS. 9-12
66—Scored lines on sides of V-shaped collars
68—Tray for panel 62 with V-shaped collars

### DETAILED DESCRIPTION OF THE INVENTION

For illustrative purposes only, preferred modes for carrying out the invention are described herein, wherein a portable display supports gift wrap rolls, and optional accessories, such as ribbon bows and/or adhesive tape dispensers.

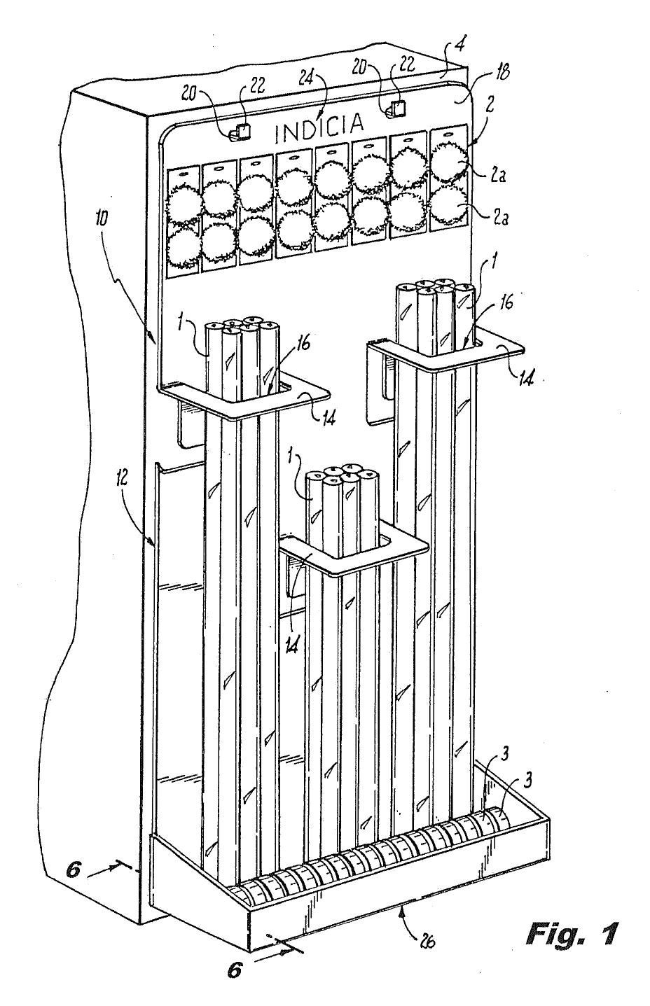

As shown in FIGS. 1-8, the wrapping paper roll displays disclose stash the rolls vertically as in a first embodiment, as well as to stack in the rolls horizontally in a further embodiment shown in FIGS. 9-12. While size may vary, the portable gift wrap roll display has preferable dimensions as 43″×18″×31/4 “, (with 4” hooks).

The portable display 10 shown in FIG. 1 holds rolls 1 of gift wrapping paper, and optionally decorative ribbon bow packages 2, and/or adhesive tape dispensers 3. Display 10 includes main panel 12 having cut out foldable restraining harnesses or collars 14 having recess 1 therein for storing rolls 1 in a generally vertical position for retail sale.

A top panel portion 18 above the top of the main panel 12 supporting the vertically supported gift wrap rolls 1 supports packages 2 gift wrap ribbon bows 2a for display.

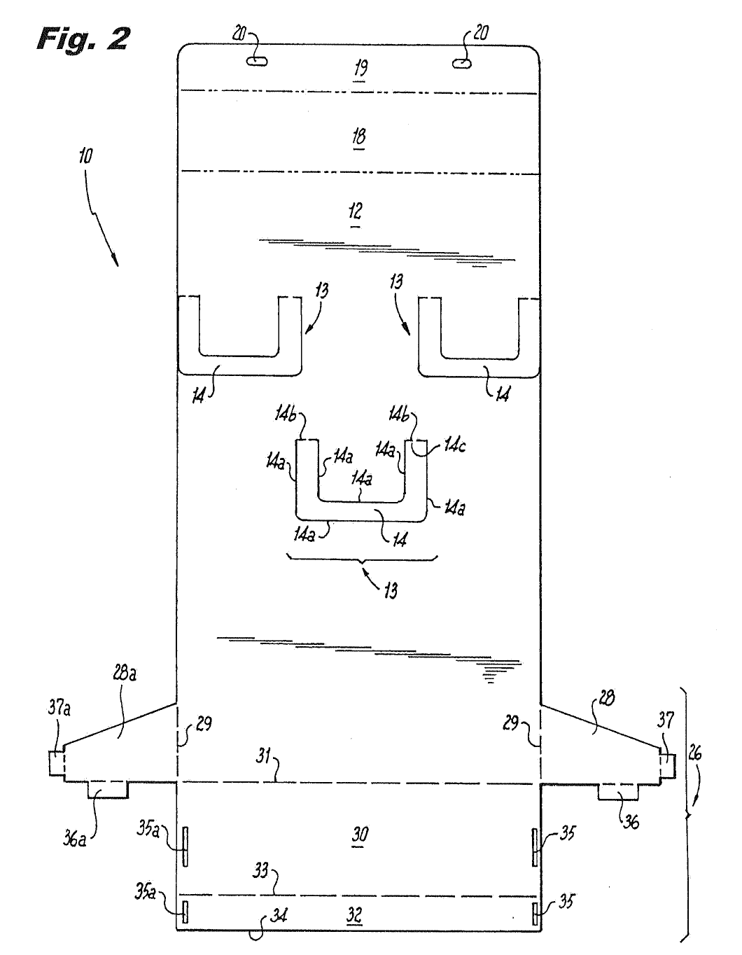

An approximately 3 inch rise 19 over top panel portion 18 supporting the upper ribbon bows 5 has attachment means, such as apertures 20 for insertion of hooks 22 or rods therethrough. The hooks 21 extend from a wall, doo or retail shelf end wall 4. A central region of rise 19 is provided or indicia 24 with brand name recognition FIG. 2 also shows the portable gift wrap roll display panel 10 with cut-out templates 13, which form collars 14 in a C-shape configuration, which are cut out with scoring on three sides, with a fourth side 14b being attached to the panel 10, wherein the C-shaped collars 14 are bent outwardly and upwardly from the flat panel 10 with the recess 16 provided therein, for insertion of one or more gift wrap rolls 1 (typically 18″m 24″ ir 30″ in length) therein.

To keep the rolls 1 from falling down, the bottoms 1a thereof are supported in a lower tray 26 having a pair of wings 28, 28a which are bendable at respective opposite edges 29 of the flat panel 12, and a lower tab portion 30 bendable along the bottom edge 31 of the panel 12 and again bendable in a further lower tab portion 32 at foldable line 33, and having distal edge 34 parallel to the bottom edge 31 of display panel 12, where holes 35, 35a are provided for insertion of further attachment extending tabs 36, 36a of the wings 28, 28a joining the lower tabs 36, 36a to form the side walls 28, 28a of a rectangular tray at the bottom of the flat panel display for gift wrap rolls. The front wall of tray 26 is formed by the further lower tab portion 32 joining forward extending further tabs 37, 37a of wings 28, 28a, which are inserted in apertures 35, 35a of further lower tab portion 32.

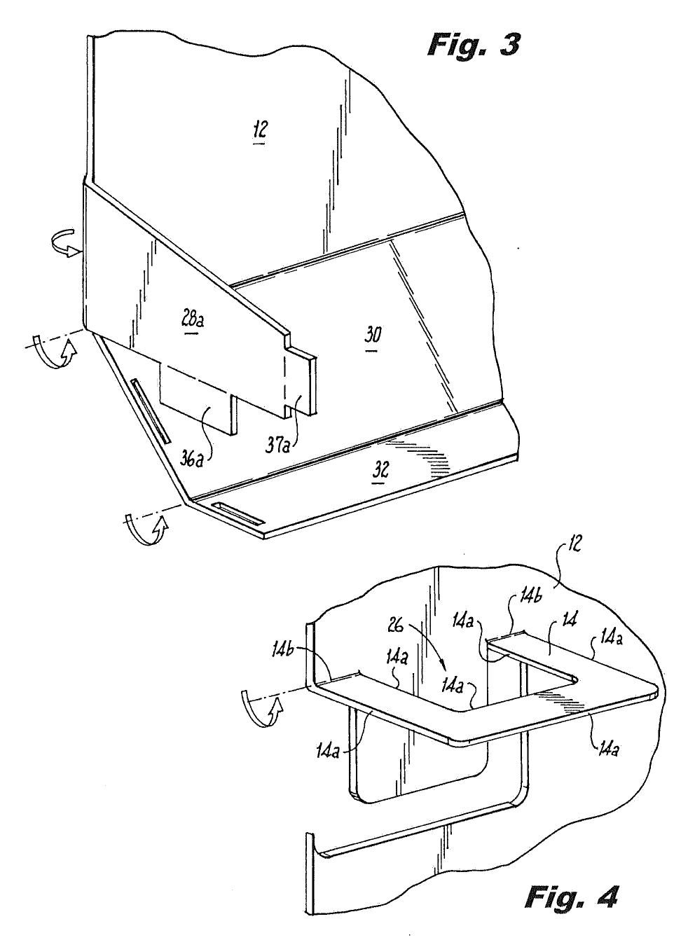

FIG. 3 shows the formation of part of the bottom tray 26 by folding and joining wing 28a with lower tab portion 30 and further lower tab portion 32, to form a hollow, open-topped box-like tray 26 at the bottom of display panel 12, in the directional arrows shown.

FIG. 4 also shows the cutting and folding of the C-shaped restraint harnesses or collars 14 for holding the gift wrap rolls 1 therein, in the directional arrow shown therein.

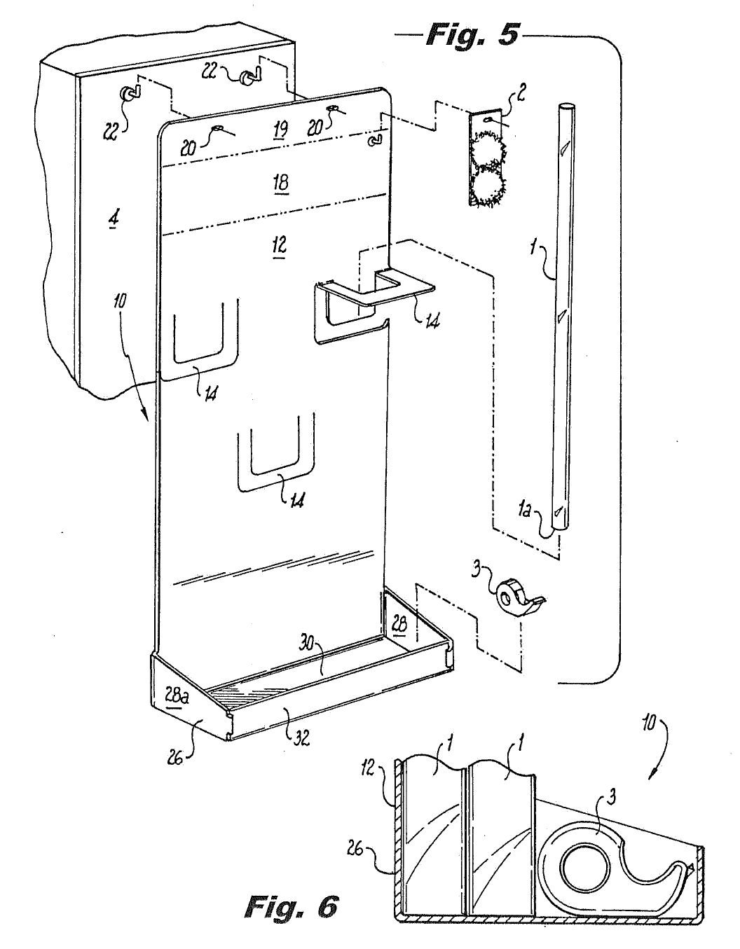

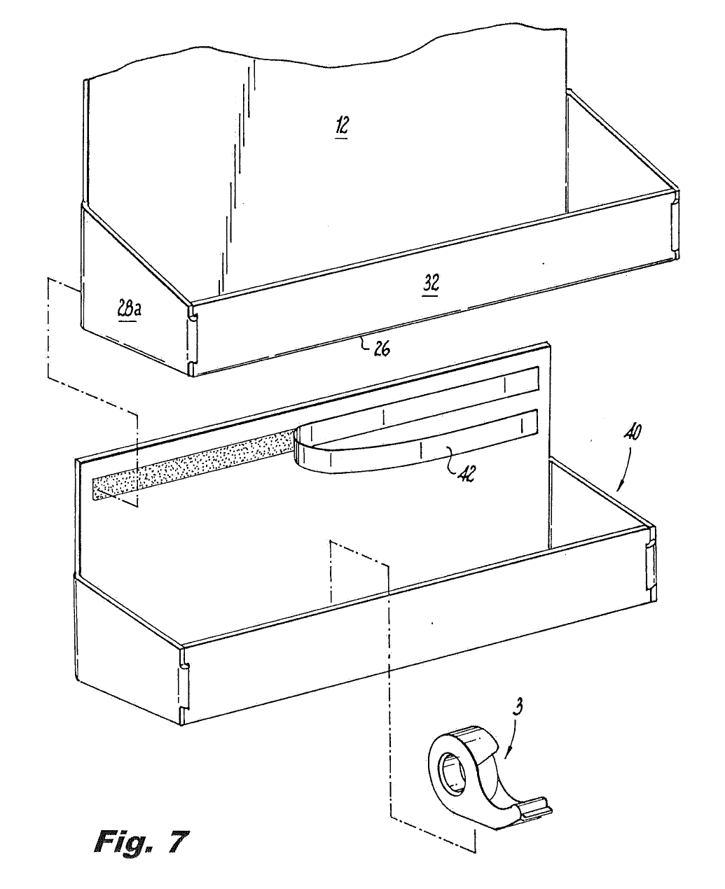

FIGS. 5 and 6 show how the gift wrap rolls 1, adhesive bow packages 2 and adhesive tape dispensers 3 are supported on the gift wrap roll display 10. FIG. 6 shows how the bottom tray 26 accommodates gift wrap rolls 1 behind the displayed adhesive tape dispensers 3 therein.

As shown in FIG. 7, for additional storage, a further auxiliary tray 40 for adhesive tape dispensers 3 can be attached by strips of fasteners 42, such as Velcro® hook and loop strip or double sided tape or tape behind the display panel 10, suspending the auxiliary tray 40 below the primary tray 26, suspending the auxiliary tray 40 below the primary tray 26 of the main panel 12 of display 10.

FIG. 8 shows an alternate embodiment for a series of gift wrap roll restraining collars 54, which each hold a single gift wrap roll 1 therein.

FIGS. 9-12 show a further alternate embodiment of display 60 where the rolls 1 are supported by punch out restraint collars extending from main panel 62 that hold respective gift wrap rolls 1 horizontally therein, wherein the restraining collars are formed from V-shaped foldable cutouts 64 formed by templates of foldable sub-panels 64a, 64b foldable at horizontal mid fold line 64b and scored punch out lines 66, 66a.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention.

I claim:

1. A portable gift wrap roll display for displaying gift wrap rolls in retail establishments, comprising:
an upright flat display panel having foldable cutouts forming retainers to hold gift wrap rolls therein for display;
said cutouts cut from said flat display panel along scored edges and a non-cut foldable edge joining said flat panel and said cutouts; and,
said flat display panel being held positionally upright by at least one holder device maintaining said flat display panel positionally secure in said upright position.

2. The portable gift wrap roll display as in claim 1 wherein said gift wrap roll retainers are punch-out C-shaped rectangular retainer harnesses.

3. The portable gift wrap roll display as in claim 1 wherein said gift wrap roll retainers are punch-out collar sections.

4. The portable gift wrap roll display as in claim 1 wherein said positionally upright holder device for said upright flat display panel includes upper apertures engaging protruding wall or door fasteners.

5. The portable gift wrap roll display as in claim 1 wherein said positionally upright holder device for said upright flat display panel includes a lower foldable base to render the gift wrap roll display self standing upon a floor or horizontal shelf surface.

6. The portable gift wrap roll display as in claim 1 wherein said upright flat display panel includes a foldable open bin to store accessories, selected from the group consisting of ribbon, gift labels, ribbon bows, or adhesive tape dispensers.

7. The portable gift wrap roll display as in claim 6 wherein said foldable open bin is located at a top region of said upright flat display panel.

8. The portable gift wrap roll display as in claim 6 wherein said foldable open bin is located at a mid region of said upright flat display panel.

9. The portable gift wrap roll display as in claim 6 wherein said foldable open bin is located at a lower region of said upright flat display panel.

10. The portable gift wrap roll display as in claim 1 wherein said foldable cutout retainers are oriented to store said gift wrap roll displays vertically.

11. The portable gift wrap roll display as in claim 1 wherein said foldable cutout retainers are oriented to store said gift wrap roll displays horizontally.

12. The portable gift wrap roll display as in claim 7 wherein said upright flat display panel includes a rise over the top of the upper foldable bin, said rise having said apertures for accommodating protruding attachments, such as hooks or rods, therethrough, for maintaining said upright flat display panel in an upright position against a vertical surface.

13. The portable gift wrap roll display as in claim 2 wherein said C-shaped restraining harnesses are cut out on three sides, with a fourth foldable side being foldably attached to the panel, wherein the C-shaped portions are bent outwardly and upwardly from the flat panel, with a recess provided therein, for insertion of one or more gift wrap rolls therein, in a generally vertical storage display orientation.

14. The portable gift wrap roll display as in claim 5 wherein said lower foldable base to maintain said upright flat display panel self-standing includes a tray having a horizontally extending flat floor engaging surface.

15. The portable gift wrap roll display as in claim 1 wherein said holder device further comprises a tray keeping the vertically stored wrapping paper rolls from falling down, wherein the bottoms of said rolls thereof are supported in a lower tray having a pair of wings which are bendable at respective opposite edges of the main flat panel, and a lower tab portion bendable along the bottom edge of the main flat panel and again bendable parallel to the bottom edge, where respective holes are provided for insertion of further attachment tabs of the wings, joining said lower tabs portion, to form a rectangular tray at the bottom of said upright flat panel display for retaining respective bottoms of the gift wrap rolls.

16. The portable gift wrap roll display as in claim 15 wherein the formation of the bottom tray is achieved by folding and joining edge wing portions to form a hollow, open-topped box-like tray portion at the bottom of said upright flat display panel.

17. The portable gift wrap roll display as in claim 1 wherein for additional storage, a further auxiliary tray is attachable by fasteners behind the display panel, suspending said auxiliary tray below a first primary tray of said upright flat display panel.

18. The portable gift wrap roll display as in claim 2 wherein said cutout roll retainers are cut out with scoring on three sides, with a fourth foldable side being attached to said upright flat panel, wherein said cutout collars are bent outwardly and upwardly from said upright flat panel with a roll retaining recess provided therein, for insertion of one or more gift wrap rolls therein.

19. The portable gift wrap roll display as in claim 2 wherein each of said gift wrap roll restraining collars holds a single gift wrap roll therein.

20. The portable gift wrap roll display as in claim 11 wherein where the gift wrap rolls are horizontally supported by punch out retainer collars extending from said upright flat holding panel respective gift wrap rolls horizontally therein, wherein said retainer collars are formed from V-shaped foldable cutouts formed by templates of foldable sub-panels foldable at a respective horizontal mid fold line and scored punch out lines, forming diamond shaped retainer collars.

21. A portable gift wrap roll display for displaying gift wrap rolls in retail establishments, comprising:
an upright flat display panel having foldable cutouts forming retainers to hold gift wrap rolls therein for display;
said cutouts cut from said flat display panel along scored edges and a non-cut foldable edge joining said flat panel and said cutouts;
said flat display panel being held positionally upright by at least one holder device maintaining said flat display panel positionally secure in said upright position;
said positionally upright holder device for said upright flat display panel includes upper holes extending therethrough and engaging protruding wall or door fasteners of a vertical support surface;
said upright flat display panel includes a foldable open bin to store accessories, selected from the group consisting of ribbon, gift labels, ribbon bows, or adhesive tape dispensers;
said foldable cutout retainers are oriented to store said gift wrap roll displays vertically;
said retainers are C-shaped restraining harnesses are cut out on three sides, with a fourth foldable side being foldably attached to the panel, wherein the C-shaped portions are bent outwardly and upwardly from the flat panel, with a recess provided therein, for insertion of one or more gift wrap rolls therein, in a generally vertical storage display orientation;
wherein said holder device further comprises a tray keeping the vertically stored wrapping paper rolls from falling down, wherein the bottoms of said rolls thereof are supported in a lower tray having a pair of wings which are bendable at respective opposite edges of the main flat panel, and a lower tab portion bendable along the bottom edge of the main flat panel and again bendable parallel to the bottom edge, where respective holes are provided for insertion of further attachment tabs of the wings, joining said lower tabs portion, to form a rectangular tray at the bottom of said upright flat panel display for retaining respective bottoms of the gift wrap rolls; and,
wherein the formation of the bottom tray is achieved by folding and joining edge wing portions to form a hollow, open-topped box-like tray portion at the bottom of said upright flat display panel.

22. A portable gift wrap roll display for displaying gift wrap rolls in retail establishments, comprising:
an upright flat display panel having foldable cutouts forming retainers to hold gift wrap rolls therein for display;
said cutouts cut from said flat display panel along scored edges and a non-cut foldable edge joining said flat panel and said cutouts;
said flat display panel being held positionally upright by at least one holder device maintaining said flat display panel positionally secure in said upright position;
said positionally upright holder device for said upright flat display panel includes a lower foldable base to render the gift wrap roll display self standing upon a floor or horizontal shelf surface;
wherein said upright flat display panel includes a foldable open bin to store accessories, selected from the group consisting of ribbon, gift labels, ribbon bows, or adhesive tape dispensers;
wherein said foldable cutout retainers are oriented to store said gift wrap roll displays horizontally;
wherein said lower foldable base to maintain said upright flat display panel self-standing includes a tray having a horizontally extending flat floor engaging surface;
wherein where the gift wrap rolls are horizontally supported by punch out retainer collars extending from said upright flat holding panel respective gift wrap rolls horizontally therein; and,
wherein said retainer collars are formed from V-shaped foldable cutouts formed by templates of foldable sub-panels foldable at a respective horizontal mid fold line and scored punch out lines, forming diamond shaped retainer collars.
